(19) United States
(12) Patent Application Publication
(10) Pub. No.: US 2013/0131940 A1
(43) Pub. Date: May 23, 2013

(54) VEHICLE AND DRIVE CONTROL DEVICE FOR VEHICLE

(71) Applicants: Ryuji Yamamoto, Shizuoka (JP); Katsuhiro Arai, Shizuoka (JP); Kazutoshi Ishioka, Shizuoka (JP); Hiroyuki Aoki, Shizuoka (JP); Naoki Sekiguchi, Shizuoka (JP)

(72) Inventors: Ryuji Yamamoto, Shizuoka (JP); Katsuhiro Arai, Shizuoka (JP); Kazutoshi Ishioka, Shizuoka (JP); Hiroyuki Aoki, Shizuoka (JP); Naoki Sekiguchi, Shizuoka (JP)

(73) Assignee: YAMAHA HATSUDOKI KABUSHIKI KAISHA, Iwata-shi, Shizuoka (JP)

(21) Appl. No.: 13/813,751

(22) PCT Filed: Apr. 8, 2011
(86) PCT No.: PCT/JP2011/058884

§ 371 Date: Feb. 1, 2013

(30) Foreign Application Priority Data
Aug. 4, 2010 (JP) 2010-175797

(51) Int. Cl. B60W 10/06; B60W 10/101

(52) U.S. Cl. CPC B60W 10/06; B60W 10/101; B60W 30/1882
USPC 701/54

(57) ABSTRACT

A drive control device for a vehicle drives an engine at a desired fuel consumption. The drive control device includes a map which correlates each engine rotation speed with an evaluation value indicating a fuel consumption when driving the engine at that engine rotation speed. The drive control device calculates a targeted evaluation value Etg between a first evaluation value Elim1 indicating a fuel consumption when driving the engine in the fuel economy mode and a second evaluation value Elim2 indicating a fuel consumption when driving the engine in the acceleration responsive mode. The drive control device calculates a target engine rotation speed Stg correlated to the targeted evaluation value Etg by referring to the map.

### BACKGROUND OF THE INVENTION

1. Field of the Invention

The present invention relates to a drive control device for a vehicle which controls an engine and a continuously variable transmission.

2. Description of the Related Art

Conventionally, there has been available a vehicle that electronically controls the opening of a throttle valve and the transmission ratio of a continuously variable transmission by utilizing an actuator. Some vehicles control the transmission ratio of a continuously variable transmission such that the actual engine rotation speed becomes a target engine rotation speed.

A control device for a vehicle disclosed in Japanese Patent No. 2898034 described below has, as its control modes, a mode for emphasizing fuel economy (hereinafter referred to as a fuel economy mode) and a mode for emphasizing acceleration response performance of a vehicle (hereinafter referred to as an acceleration responsive mode). A target engine rotation speed is set in the fuel economy mode so as to achieve the optimal fuel consumption, while a higher target engine rotation speed than that in the fuel economy mode is set in the acceleration responsive mode so as to achieve the maximum vehicle acceleration response (in Japanese Patent No. 2898034, the acceleration response is referred to a driving force of an engine).

Japanese Patent No. 2898034 further discloses a control mode where a target engine rotation speed is set between a target engine rotation speed set in the fuel economy mode and a target engine rotation speed set in the acceleration responsive mode (hereinafter referred to as an intermediate mode). In the intermediate mode, a calculation formula which defines a relation between target engine rotation speed and an acceleration request (specifically, a change speed of a throttle opening degree) is used, and thereby a target engine rotation speed in response to an acceleration request is calculated.

According to the control disclosed in Japanese Patent No. 2898034, a target engine rotation speed is calculated based directly on an acceleration request, and thus an acceleration response and a fuel consumption to be achieved when the actual engine rotation speed reaches a target engine rotation speed is not involved in the calculation for the target engine rotation speed. Thus, according to the control disclosed in Japanese Patent No. 2898034, it is difficult to obtain an acceleration response and fuel consumption that matches a drive state of the vehicle and a driver's acceleration request.

### SUMMARY OF THE INVENTION

In order to overcome the problems described above, preferred embodiments of the present invention provide a drive control device that drives an engine in a state of a desired acceleration response and a desired fuel consumption, and a vehicle including the drive control device.

According to a preferred embodiment of the present invention, the drive control device is arranged and programmed to control an engine and a transmission ratio of a continuously variable transmission so that an operation state of the engine becomes a target operation state. The drive control device preferably includes a storage unit that stores in advance data which correlates each operation state of the engine with an evaluation value indicating a fuel consumption when driving the engine at each operation state; a target evaluation value calculation section that calculates a targeted evaluation value between a first evaluation value indicating a fuel consumption when driving the engine in a fuel economy mode, which is one control mode of the drive control device, and a second evaluation value indicating a fuel consumption when driving the engine in an acceleration responsive mode, which is another control mode of the drive control device; and a target operation state calculation section that calculates, as the target operation state, an operation state correlated to the targeted evaluation value by referring to the data stored in the storage unit.

According to another preferred embodiment of the present invention, the drive control device is arranged and programmed to control an engine and a transmission ratio of a continuously variable transmission so that an operation state of the engine becomes a target operation state. The drive control device preferably includes a storage unit that stores in advance data which correlates each operation state of the engine with an evaluation value indicating an acceleration response when driving the engine at each operation state; a target evaluation value calculation section that calculates a targeted evaluation value between a first evaluation value indicating an acceleration response when driving the engine in a fuel economy mode, which is one control mode of the drive control device, and a second evaluation value indicating an acceleration response when driving the engine in an acceleration responsive mode, which is another control mode of the drive control device; and a target operation state calculation section that calculates, as the target operation state, an operation state correlated to the targeted evaluation value by referring to the data stored in the storage unit.

Another preferred embodiment of the present invention provides a vehicle that includes the above described drive control device.

According to the preferred embodiments of the present invention, because a targeted evaluation value is calculated and then a target operation state is calculated based on the targeted evaluation value, it is possible to drive the engine at a desired fuel consumption or acceleration response. Note that an operation state may not be directly correlated to an evaluation value in the data stored in the storage unit. That is, an operation state may be correlated to an evaluation value via another parameter.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a two-wheeled motor vehicle including a drive control device according to a preferred embodiment of the present invention.

FIG. 2 schematically shows a drivetrain mechanism of the two-wheeled motor vehicle.

FIG. 3 is a functional block diagram of a control unit of the drive control device.

FIG. 4 shows a summary of a control executed by the control unit.

FIGS. 5A and 5B are summaries of a processing executed by a target engine rotation speed calculation section of the control unit.

FIG. 6 is a functional block diagram of the target engine rotation speed calculation section.

FIG. 7 shows an example of an optimal fuel consumption map stored in a storage unit.

FIG. 8 shows a fuel consumption evaluation map stored in the storage unit.

FIG. 9A shows a relationship between a fuel consumption and an engine rotation speed, FIG. 9B shows a relationship between a fuel consumption evaluation value and a fuel consumption, and FIG. 9C shows a relationship between a fuel consumption evaluation value and an engine rotation speed.

FIG. 10 shows an example of an optimal acceleration response map stored in the storage unit.

FIG. 11 shows an example of change of an acceleration request-related value.

FIG. 12 shows a relationship between the acceleration request-related value and the fuel consumption evaluation value.

FIG. 13 shows a relationship between the engine rotation speed and the acceleration request-related value.

FIG. 14A is a time chart explaining a change of the accelerator opening degree, FIG. 14B is a time chart explaining a change of the target engine power, FIG. 14C is a time chart explaining a change of the acceleration request-related value, FIG. 14D is a time chart explaining a change of the engine rotation speed, and FIG. 14E is a time chart explaining a change of a rear wheel driving force.

FIG. 15 shows an acceleration response evaluation map stored in the storage unit.

### DETAILED DESCRIPTION OF THE PREFERRED EMBODIMENTS

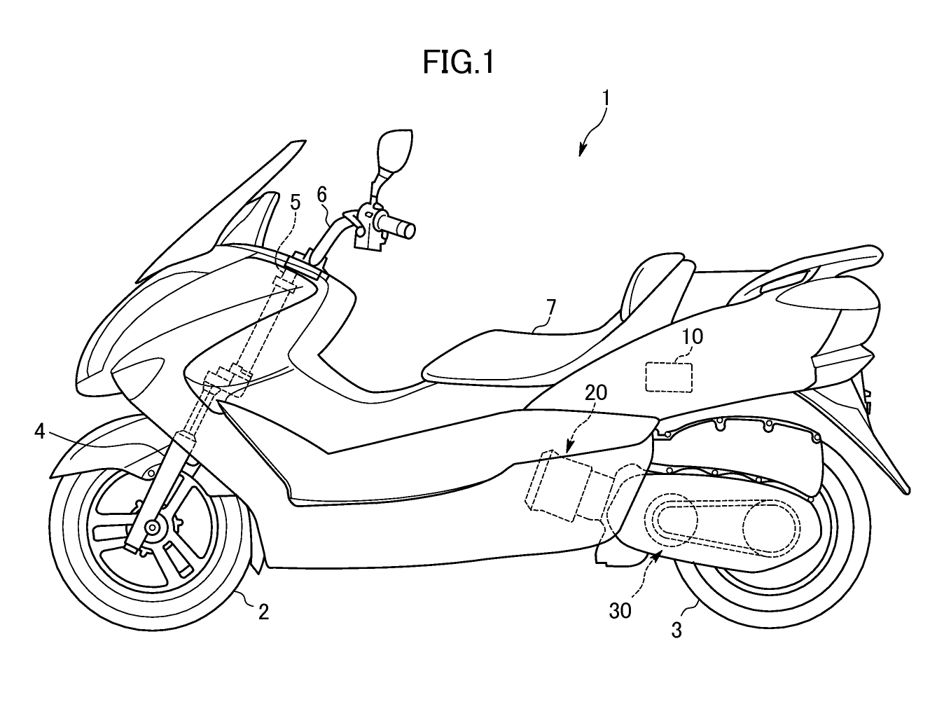

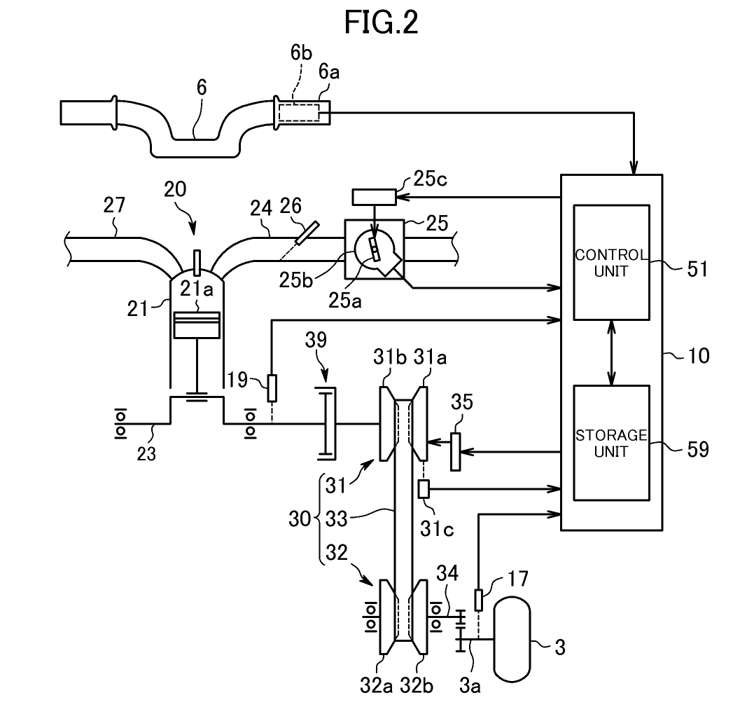

In the following, preferred embodiments of the present invention will be described with reference to the accompanying drawings. FIG. 1 is a side view of a two-wheeled motor vehicle 1 including a drive control device 10 according to a preferred embodiment of the present invention, and FIG. 2 schematically shows a drivetrain mechanism of the two-wheeled motor vehicle 1.

As shown in FIGS. 1 and 2, the two-wheeled motor vehicle 1 includes a front wheel 2 and a rear wheel 3. The two-wheeled motor vehicle 1 further includes an engine 20, a continuously variable transmission 30 that reduces the rotation speed of the engine 20 and transmits it to the rear wheel 3, and a drive control device 10 that controls the engine 20 and the transmission ratio of the continuously variable transmission 30.

As shown in FIG. 1, the front wheel 2 is supported at the lower end of a front suspension 4. A steering shaft 5 is provided at the upper portion of the front suspension 4 and is rotatably supported by the vehicle body frame (not shown). A steering bar 6 is provided above the steering shaft 5. The steering bar 6, the steering shaft 5, the front suspension 4, and the front wheel 2 can integrally turn to the left and right, and the front wheel 2 can be steered by operating the steering bar 6. As shown in FIG. 2, an accelerator grip 6a for operation by a driver is provided on the right portion of the steering bar 6.

As shown in FIG. 1, a seat 7 is mounted rearward of the steering bar 6 so that a driver can sit thereon while straddling the vehicle. The engine 20 is mounted below the seat 7. As shown in FIG. 2, the engine 20 includes a cylinder 21, and the cylinder 21 includes an intake pipe 24 connected thereto. The intake pipe 24 is provided with a fuel supply device 26 to inject fuel into the intake pipe 24. The fuel supply device 26 is preferably an electronically controlled fuel injection device.

The intake pipe 24 includes a throttle body 25 connected thereto, the throttle body 25 including a throttle valve 25a provided inside thereof. The throttle valve 25a adjusts the amount of air flowing into the cylinder 21 through the throttle body 25. The throttle valve 25a is preferably an electronically controlled valve, and the throttle body 25 includes a valve actuator 25c to open and close the throttle valve 25a while receiving power from the drive control device 10. The drive control device 10 controls the power supply to the valve actuator 25c to control the opening degree of the throttle valve 25a (hereinafter referred to as a throttle opening degree).

A piston 21a arranged inside the cylinder 21 is linked to a crank shaft 23 inside the crank case. The cylinder 21 further includes an exhaust pipe 27 connected thereto to exhaust exhaust gas generated through the combustion of fuel.

The continuously variable transmission 30 is preferably a belt-type transmission, and includes a drive pulley 31, a driven pulley 32 to which rotation is transmitted from the drive pulley 31, and a belt 33 wound around the drive pulley 31 and the driven pulley 32 to transmit the rotation of the drive pulley 31 to the driven pulley 32.

In the example shown in FIG. 2, the rotation of the crank shaft 23 is transmitted to the movable pulley 31 via a clutch 39. The clutch 39 is, for example, an automatic clutch (for example, a centrifugal clutch) that is engaged or disengaged without a clutch operation by a driver.

The drive pulley 31 includes a movable sheave 31a that is movable in the rotation axial direction and a stationary sheave 31b of which movement in the axial direction is restricted. The driven pulley 32 includes a movable sheave 32a that is movable in the rotation axial direction and a stationary sheave 32b of which movement in the axial direction is restricted. The movable sheave 32a is pressed onto the stationary sheave 32b by a spring (not shown).

When the movable sheave 31a and the stationary sheave 31b are positioned closest to each other and the movable sheave 32a and the stationary sheave 32b are positioned farthest apart from each other, the transmission ratio is set to TOP (minimum reduction ratio). On the contrary, when the movable sheave 31a and the stationary sheave 31b are positioned farthest apart from each other and the movable sheave 32a and the stationary sheave 32b are positioned closest to each other, the transmission ratio is set to LOW (maximum reduction ratio). The movable sheave 31a and the movable sheave 32a move in the axial direction to change the transmission ratio of the continuously variable transmission 30 in the range between TOP and LOW.

The continuously variable transmission 30 is preferably an electronically controlled transmission, and thus includes a sheave actuator 35 to move the movable sheave 31a in the axial direction. The drive control device 10 activates the sheave actuator 35 to move the movable sheave 31a in the axial direction to control the transmission ratio of the continuously variable transmission 30.

The driven pulley 32 is mounted on a driven shaft 34 that integrally rotates with the driven pulley 32. The driven shaft 34 is linked to the axle 3a of the real wheel 3 via a gear. With the above configuration, the rotation of the driven shaft 34 is transmitted to the rear wheel 3.

A drivetrain mechanism from the engine 20 to the axle 3a of the rear wheel 3 is not limited to that shown in FIG. 2, and various modifications may be possible. For example, the clutch 39 may be provided downstream of the continuously variable transmission 30. Further, a speed reduction mechanism may be mounted between the drive pulley 31 and the crank shaft 23.

Hereinafter, a sensor that is connected to the drive control device 10 will be described. The two-wheeled motor vehicle 1 includes an accelerator operation sensor 6b to detect the amount of operation of the accelerator grip 6a by a driver (the amount of operation is the rotational position of the accelerator grip 6a, hereinafter the amount is referred to as an accelerator opening degree). The accelerator operation sensor 6b is, for example, a potentiometer, and outputs an electric signal in accordance with the accelerator opening degree. The drive control device 10 detects the accelerator opening degree set by a driver based on an output signal from the accelerator operation sensor 6b.

The throttle body 25 includes a throttle opening degree sensor 25b to detect the throttle opening degree. The throttle opening degree sensor 25b includes, for example, a potentiometer, and outputs an electric signal in accordance with the throttle opening degree. The drive control device 10 detects the throttle opening degree based on an output signal from the throttle opening degree sensor 25b.

The continuously variable transmission 30 includes a sensor to detect the actual transmission ratio of the continuously variable transmission 30. Because the transmission ratio corresponds to the position of the movable sheave 31a, a sheave position sensor 31c that outputs an electric signal in accordance with the position of the movable sheave 31a is provided as a sensor to detect the transmission ratio. The drive control device 10 detects the transmission ratio based on an output signal of the sheave position sensor 31c.

The engine 20 includes an engine rotation speed sensor 19. The engine rotation speed sensor 19 is a rotation speed sensor that outputs an electric signal in accordance with the rotation speed of the crank shaft 23. The drive control device 10 calculates the engine rotation speed based on an output signal from the engine rotation speed sensor 19.

A vehicle speed sensor 17 is mounted on the axle 3a of the rear wheel 3. The drive control device 10 calculates the vehicle speed based on an output signal from the vehicle speed sensor 17.

The drive control device 10 includes a storage unit 59 including a RAM (Random Access Memory) and a ROM (Read Only Memory) and a control unit 51 including a microprocessor arranged and programmed to execute programs stored in the storage unit 59. The drive control device 10 includes a drive circuit (not shown) to supply a driving power to the valve actuator 25c in response to a signal input from the control unit 51, and a drive circuit to supply a driving power to the sheave actuator 35 in response to a signal input from the control unit 51.

Output signals from the engine rotation speed sensor 19, the vehicle speed sensor 17, the accelerator operation sensor 6b, the throttle opening degree sensor 25b, and the sheave position sensor 31c are input to the control unit 51 via an interface circuit (not shown). The control unit 51 detects the engine rotation speed or the like based on these output signals from the respective sensors.

The control unit 51 sets a target operation state of the engine 20, and controls the engine 20 and the transmission ratio of the continuously variable transmission 30 such that the actual operation state becomes equal to the target operation state. Specifically, the control unit 51 sets a targeted engine rotation speed, and controls the transmission ratio of the continuously variable transmission 30 such that the actual engine rotation speed becomes equal to the targeted engine rotation speed. Further, the control unit 51 sets a targeted engine torque, and controls the engine 20 such that the actual engine torque becomes equal to the targeted engine torque. In the present example described herein, the control unit 51 controls the throttle opening degree in order to obtain a targeted engine torque. Alternatively, the control unit 51 may control ignition timing of the engine 20 and the injected amount of fuel injected by the fuel supply device 26 in order to obtain a targeted engine torque. Control by the control unit 51 will be described below in detail.

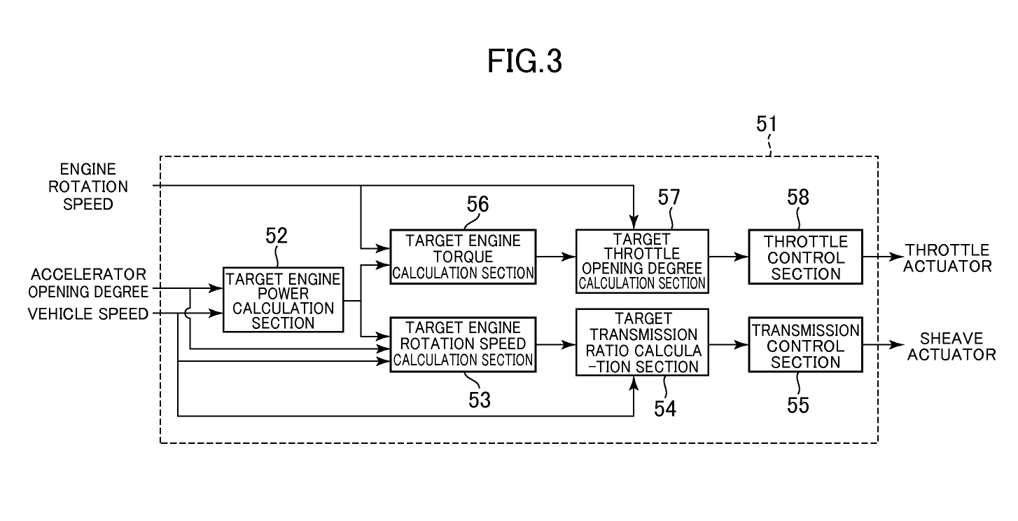

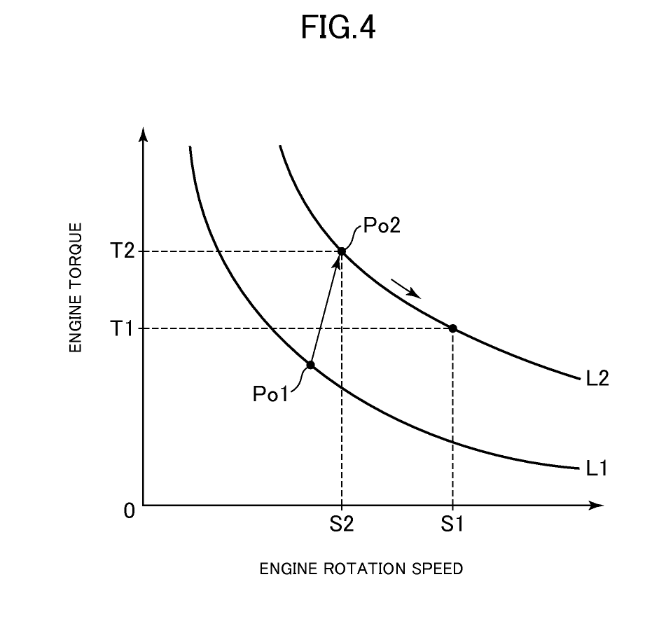

Hereinafter, a control executed by the control unit 51 will be described. FIG. 3 is a block diagram showing functions of the control unit 51. FIG. 4 describes an outline of a control executed by the control unit 51, in which the x-axis indicates the engine rotation speed, the y-axis indicates the engine torque, and L1 is an example of an equivalent power curve line indicating operation states (the engine rotation speed, the engine torque) where similar engine powers can be output. The point Po1 on the equivalent power curve line L1 indicates the current operation state. Line L2 is an example of an equivalent power curve line connecting operation states where a targeted engine power can be obtained.

As shown in FIG. 3, the control unit 51 includes, as its functions, a target engine power calculation section 52, a target engine rotation speed calculation section 53, a target transmission ratio calculation section 54, a transmission control section 55, a target engine torque calculation section 56, a target throttle opening degree calculation section 57, and a throttle control section 58.

The target engine power calculation section 52 calculates a targeted engine power (hereinafter referred to as a target engine power) based on the accelerator opening degree detected by the accelerator operation sensor 6b and the vehicle speed detected by the vehicle speed sensor 17.

In this example, a map that correlates the accelerator opening degree, the vehicle speed, and the targeted driving force of the rear wheel 3 (hereinafter referred to as a target driving force) is stored in advance in the storage unit 59. With reference to the map, the target engine power calculation section 52 calculates a target driving force correlated to the detected accelerator opening degree and vehicle speed. Then, the target engine power calculation section 52 calculates the target engine power based on the target driving force. Specifically, the target engine power calculation section 52 multiplies the target driving force by the detected vehicle speed to calculate the target engine power.

The target engine rotation speed calculation section 53 calculates a targeted engine rotation speed (hereinafter referred to as a target engine rotation speed) based on the target engine power and the detected accelerator opening degree and vehicle speed. Referring to FIG. 4, the target engine rotation speed calculation section 53 calculates, as the target engine rotation speed, an engine rotation speed (for example, S1) associated with the detected accelerator opening degree and vehicle speed among the engine rotation speeds of the operation states indicated by the equivalent power curve line L2 indicating the target engine power. The target engine rotation speed calculation section 53 calculates the target engine rotation speed in a predetermined cycle. Processing by the target engine rotation speed calculation section 53 will be described below in detail.

The target transmission ratio calculation section 54 calculates a targeted transmission ratio (hereinafter referred to as a target transmission ratio) based on the target engine rotation speed and the vehicle speed. Specifically, the target transmission ratio calculation section 54 divides the target engine rotation speed by the detected vehicle speed to calculate the target transmission ratio.

The transmission control section 55 moves the sheave actuator 35 so that the actual transmission ratio becomes equal to the target transmission ratio. That is, the transmission control section 55 calculates the position of the movable sheave 31a corresponding to the target transmission ratio, and moves the sheave actuator 35 such that the position of the movable sheave 31a detected by the sheave position sensor 31c coincides with the position corresponding to the target transmission ratio. When the actual transmission ratio changes toward the target transmission ratio, the actual engine rotation speed increases or decreases toward the target engine rotation speed.

The target engine torque calculation section 56 calculates a targeted engine torque (hereinafter referred to as a target engine torque) based on the above-described target engine power and the current engine rotation speed detected by the engine rotation speed sensor 19. Specifically, the target engine torque calculation section 56 divides the target engine power by the current engine rotation speed to calculate the target engine torque.

Referring to FIG. 4, when the current engine rotation speed has not yet reached the target engine rotation speed (S1 in the example shown in FIG. 4) but remains at the engine rotation speed S2, the target engine torque calculation section 56 calculates, as the target engine torque, an engine torque T2 in an operation state with the engine rotation speed S2 (point Po2 in FIG. 4) among the operation states indicated by the equivalent power curve line L2. When the actual engine rotation speed becomes closer to the target engine rotation speed, the target engine torque becomes closer to the engine torque corresponding to the target engine rotation speed (T1 in FIG. 4). In the above, in a case in which the target engine torque calculated as described above is larger than the maximum engine torque that can be output at the current engine rotation speed (an engine torque that can be obtained with the maximum throttle opening degree), the maximum engine torque is set as the target engine torque. The target engine torque calculation section 56 as well calculates the target engine torque in a predetermined cycle, similar to the target engine rotation speed calculation section 53.

The target throttle opening degree calculation section 57 calculates a targeted throttle opening degree (hereinafter referred to as a target throttle opening degree) based on the target engine torque. In this example, a map that correlates the engine torque, the throttle opening degree, and the engine rotation speed (hereinafter referred to as an engine torque map) is stored in advance in the storage unit 59. The target throttle opening degree calculation section 57 calculates, as the target throttle opening degree, a throttle opening degree correlated to the target engine torque and the current engine rotation speed, by referring to the engine torque map.

The throttle control section 58 moves the valve actuator 25c such that the throttle opening degree detected by the throttle opening degree sensor 25b becomes equal to the target throttle opening degree.

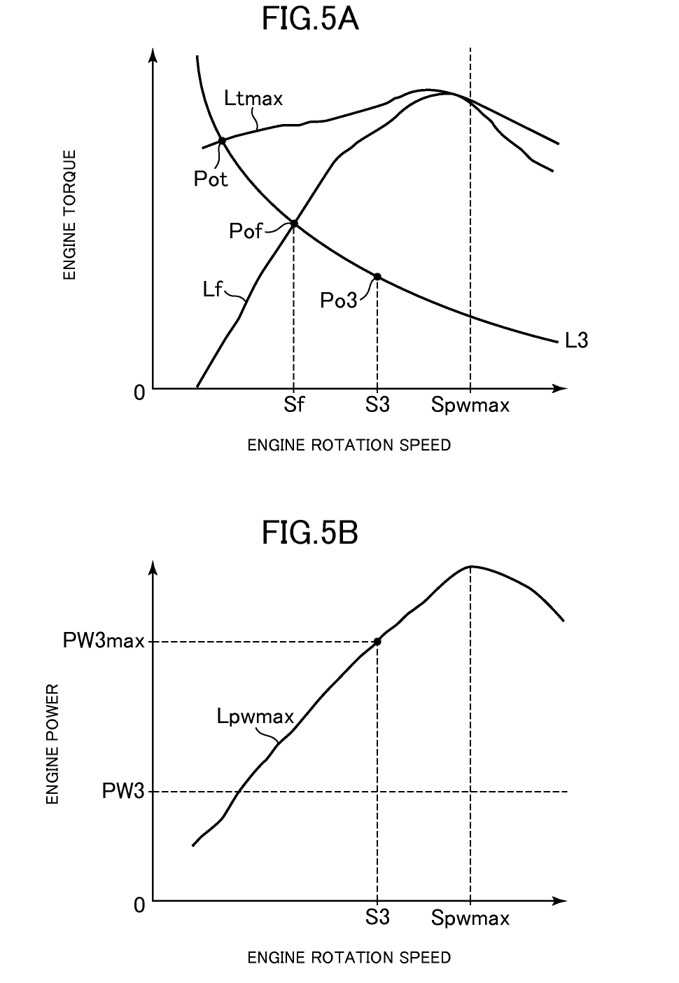

Hereinafter, processing by the target engine rotation speed calculation section 53 will be described. FIGS. 5A and 5B explain an outline of processing by the target engine rotation speed calculation section 53. In the graph shown in FIG. 5A, the x-axis indicates the engine rotation speed, while the y-axis indicates the engine torque. In the graph, line L3 is an example of an equivalent power curve line indicating operation states where the target engine power can be obtained. Line Lf indicates operation states of the optimal fuel consumption (hereinafter referred to as an optimal fuel consumption curve line). Line Ltmax indicates the maximum engine torque that can be obtained at each engine rotation speed (hereinafter referred to as the maximum torque curve line). Meanwhile, in the graph shown in FIG. 5B, the x-axis indicates the engine rotation speed, while the y-axis indicates the engine power. In the graph shown in FIG. 5B, line Lpwmax indicates the maximum engine power that can be obtained at each engine rotation speed.

The drive control device 10 includes, as its control modes, a fuel economy mode and an acceleration responsive mode. The drive control device 10 includes another control mode, that is, an intermediate mode where an operation state is achieved between the operation state in the fuel economy mode and the operation state in the acceleration responsive mode. These control modes are switched between one another by a driver operating a switch (not shown) mounted on, for example, the steering bar 6 or the like. Alternatively, the control mode may be automatically switched by the drive control device 10, depending on the drive state of the vehicle, without a switching operation by a driver.

In the fuel economy mode, the target engine rotation speed calculation section 53 calculates, as the target engine rotation speed, an engine rotation speed to achieve the optimal fuel consumption (hereinafter referred to as a fuel economy rotation speed) in the operation states (operation states on the equivalent power curve line L3 in FIG. 5A) where the target engine power can be obtained. In the example shown in FIG. 5A, the engine rotation speed Sf at the cross point Pof between the equivalent power curve line L3 and the optimal fuel consumption curve line Lf is the fuel economy rotation speed, and is set as the target engine rotation speed.

When the engine rotation speed Sf at the cross point Pof exceeds the range of the engine rotation speed that is defined by the upper and lower limits of the transmission ratio (that is, when the engine rotation speed Sf is lower than the engine rotation speed calculated from a product of the current vehicle speed times the minimum reduction ratio (the TOP reduction ratio)), the lowest engine rotation speed is set as the target engine rotation speed.

In the acceleration responsive mode, the target engine rotation speed calculation section 53 calculates, as the target engine rotation speed, an engine rotation speed of the optimal acceleration response (hereinafter referred to as a responsive rotation speed) in the operation states where the target engine power can be obtained.

In this preferred embodiment, the acceleration response is defined as a capability corresponding to a rear wheel driving force that can be obtained immediately after an accelerative operation performed by a driver (an operation on the accelerator grip 6a). That is, acceleration response in a certain operation state is expressed as, for example, a ratio between the engine power at that operation state and the maximum engine power that can be obtained at an engine rotation speed same as that of that operation state. In FIG. 5B, the acceleration response in the operation state Po3 is expressed as a ratio (PW3max/PW3) of the engine power PW3 in the operation state Po3 relative to the maximum engine power PW3max which can be obtained at the engine rotation speed S3 of that operation state Po3 (see FIG. 5B), hereinafter the ratio is referred to as a margin engine power ratio).

When a driver operates the accelerator grip 6a, it is possible to immediately increase the engine torque by increasing the throttle opening degree. However, it takes time to increase the engine rotation speed because it is necessary to move the movable sheave 31a. In view of this, when the engine 20 is driven in advance so as to remain in an operation state with a large margin engine power ratio, a large engine power can be instantly obtained upon an accelerative operation being performed, without waiting for an increase of the engine rotation speed. Consequently, it is possible to obtain a large rear wheel driving force instantly after an acceleration operation is performed.

In the acceleration responsive mode, the target engine rotation speed calculation section 53 calculates, as the target engine rotation speed, an engine rotation speed of an operation state with the maximum margin engine power ratio among the operation states where the target engine power can be obtained. Therefore, when the range of the engine rotation speed defined by the upper and lower limits of the transmission ratio is disregarded, the margin engine power ratio is maximized at the engine rotation speed Spwmax (see FIG. 5B) at which the maximum engine power is obtained. Therefore, the target engine rotation speed calculation section 53 sets the engine rotation speed Spwmax as the target engine rotation speed.

When the engine rotation speed Spwmax exceeds the range of the engine rotation speed that is defined by the upper and lower limits of the transmission ratio (that is, (i) when the engine rotation speed Spwmax is higher than the engine rotation speed (the highest engine rotation speed) calculated from a product of the current vehicle speed times the maximum reduction ratio (a LOW reduction ratio), or (ii) when the engine rotation speed Spwmax is lower than the engine rotation speed (the lowest engine rotation speed) calculated from a product of the vehicle speed times the minimum reduction ratio (a TOP reduction ratio)), the target engine rotation speed calculation section 53 calculates the highest or lowest engine rotation speed as the target engine rotation speed.

In the intermediate mode, the target engine rotation speed calculation section 53 sets a target engine rotation speed between the target engine rotation speed set in the fuel economy mode (Sf in the example shown in FIG. 5A) and the target engine rotation speed set in the acceleration responsive mode (Spwmax in the example shown in FIG. 5A).

In this preferred embodiment, the storage unit 59 has data stored therein which correlates each operation state of the engine 20 with an evaluation value (hereinafter referred to as a fuel consumption evaluation value) indicating a fuel consumption obtained at each operation state. In this example, the storage unit 59 has a map stored therein which correlates each engine rotation speed with the fuel consumption evaluation value indicating a fuel consumption obtained at each engine rotation speed. The target engine rotation speed calculation section 53 sets a target as to the fuel consumption value, and calculates the target engine rotation speed based on the target by referring to the map stored in the storage unit 59.

In this preferred embodiment, the target engine rotation speed calculation section 53 calculates a targeted fuel consumption evaluation value (hereinafter referred to as a target fuel consumption evaluation value) between a fuel consumption evaluation value indicating a fuel consumption when driving the engine 20 in the fuel economy mode (hereinafter referred to as a first limit evaluation value) and a fuel consumption evaluation value indicating a fuel consumption when driving the engine 20 in the acceleration responsive mode (hereinafter referred to as a second limit evaluation value). Then, with reference to the map stored in the storage unit 59, the target engine rotation speed calculation section 53 calculates, as the target engine rotation speed, an engine rotation speed correlated to the target fuel consumption evaluation value. With the above configuration, it is possible to drive the engine 20 at a fuel consumption corresponding to the target fuel consumption evaluation value when the actual engine rotation speed reaches the target engine rotation speed.

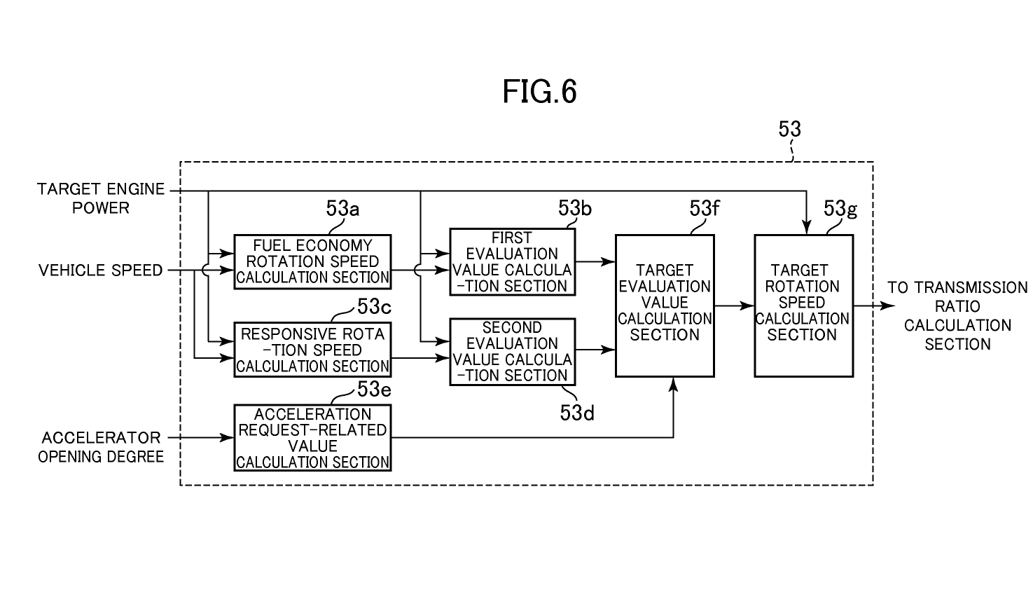

Hereinafter, processing executed by the target engine rotation speed calculation section 53 will be described. FIG. 6 is a block diagram showing functions of the target engine rotation speed calculation section 53. As shown in the diagram, the target engine rotation speed calculation section 53 includes a fuel economy rotation speed calculation section 53a, a first evaluation value calculation section 53b, a responsive rotation speed calculation section 53c, a second evaluation value calculation section 53d, an acceleration request-related value calculation section 53e, a target evaluation value calculation section 53f, and a target rotation speed calculation section 53g.

The fuel economy rotation speed calculation section 53a calculates the above described fuel economy rotation speed based on the vehicle speed detected by the vehicle speed sensor 17 and the target engine power. The fuel economy rotation speed in this example is an engine rotation speed of the optimal fuel consumption in the range of the engine rotation speed defined by the upper and lower limits of the transmission ratio and the vehicle speed (that is, a range of the engine rotation speed allowed by changing the transmission ratio). In the storage unit 59, a map which correlates the fuel economy rotation speed, the vehicle speed, and the engine power (hereinafter referred to as an optimal fuel consumption map) is stored. With reference to the optimal fuel consumption map, the fuel economy rotation speed calculation section 53a calculates a fuel economy rotation speed correlated to the current vehicle speed and the target engine power.

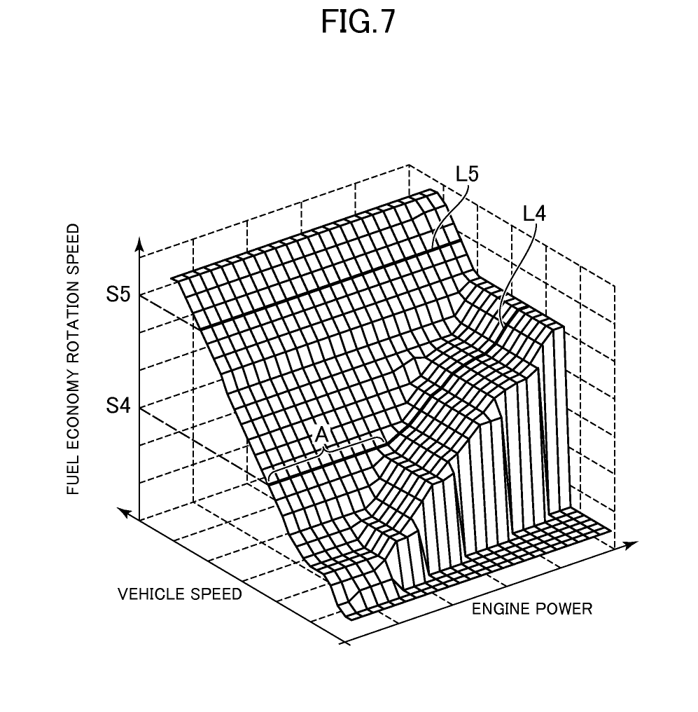

FIG. 7 shows an example of the optimal fuel consumption map. In this diagram, three respective axes indicate the engine power, the vehicle speed, and the fuel economy rotation speed.

When the range of the engine rotation speed allowed by changing the transmission ratio is disregarded, an engine rotation speed of the optimal fuel consumption increases as the engine power increases, generally. That is, an engine rotation speed of the optimal fuel consumption (hereinafter referred to as a provisional fuel economy rotation speed) increases throughout the entire range of the engine rotation speeds as an engine power increases. Basically, a provisional fuel economy rotation speed is set as the fuel economy rotation speed. That is, in an operation area where the provisional fuel economy rotation speed can be realized by changing the transmission ratio (an operation area which has a provisional fuel economy rotation speed higher than the lowest engine rotation speed), the provisional fuel economy rotation speed is set as the fuel economy rotation speed. Thus, in this operation area, as indicated by line L4 in FIG. 7, the fuel economy rotation speed increases as the engine power increases, while the vehicle speed remains constant.

The fuel economy rotation speed is defined in the optimal fuel consumption map within a range allowed by changing the transmission ratio. Thus, when the provisional fuel economy rotation speed is lower than the engine rotation speed allowed by changing the transmission ratio, that is, when the provisional fuel economy rotation speed is lower than the above-described lowest engine rotation speed, the lowest engine rotation speed is set as the fuel economy rotation speed. As indicated by line L5 and the range A of line L4 in FIG. 7, when the provisional fuel economy rotation speed is lower than the lowest engine rotation speed (for example, S5, S4), the lowest engine rotation speed is set as the fuel economy rotation speed.

As indicated by line L5, in the range where the lowest engine rotation speed is higher than the engine rotation speed Spwmax at which the maximum engine power can be obtained (see FIG. 5B), the lowest engine rotation speed is set as the fuel economy rotation speed with respect to all engine powers.

The first evaluation value calculation section 53b calculates the first limit evaluation value based on the fuel economy rotation speed calculated by the fuel economy rotation speed calculation section 53a. In this example, a map which correlates the engine rotation speed, the engine power, and the fuel consumption evaluation value indicating a fuel consumption when driving the engine 20 (hereinafter referred to as a fuel consumption evaluation map) is stored in the storage unit 59. With reference to the fuel consumption evaluation map, the first evaluation value calculation section 53b calculates, as the first limit evaluation value, a fuel consumption evaluation value correlated to the calculated fuel economy rotation speed and target engine power.

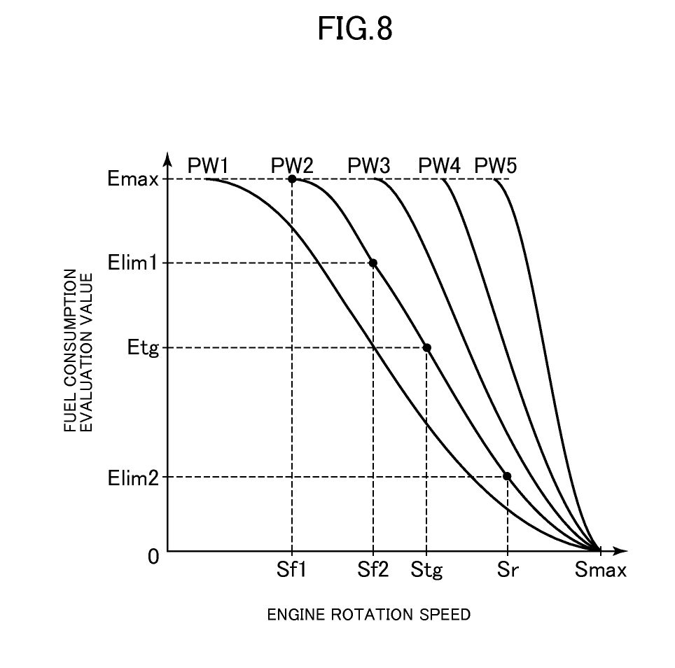

FIG. 8 explains the fuel consumption evaluation map, in which the x-axis indicates the engine rotation speed and the y-axis indicates the fuel consumption evaluation value. The line shown in the diagram indicates a relationship between the engine rotation speed and the fuel consumption evaluation value as to each of the engine powers PW1 to PW5 (PW1<PW2< . . . <PW5).

When the fuel consumption is defined as a distance which a vehicle can travel by a unit fuel amount, generally, the fuel consumption decreases as the engine rotation speed increases. Thus, in the fuel consumption evaluation map, as shown in FIG. 8, the fuel consumption evaluation value decreases as the engine rotation speed increases, while the engine power remains constant.

In the fuel consumption evaluation map, the maximum fuel consumption evaluation value (Emax in the example shown in FIG. 8) is correlated to the provisional fuel economy rotation speed as to each engine power. Further, in the fuel consumption evaluation map, the minimum fuel consumption evaluation value (0 in FIG. 8) is correlated to an engine rotation speed of the worst fuel consumption as to each engine power (specifically, the maximum engine rotation speed Smax allowed by the engine 20). Thus, as shown in FIG. 8, when the target engine power is PW2 and the provisional fuel economy rotation speed Sf1 is calculated as the fuel economy rotation speed, the maximum fuel consumption evaluation value Emax is calculated as the first limit evaluation value. Meanwhile, when a lowest engine rotation speed Sf2 higher than the provisional fuel economy rotation speed Sf1 is calculated as the fuel economy rotation speed, a value Elim1 lower than the fuel consumption evaluation value Emax is calculated as the first limit evaluation value.

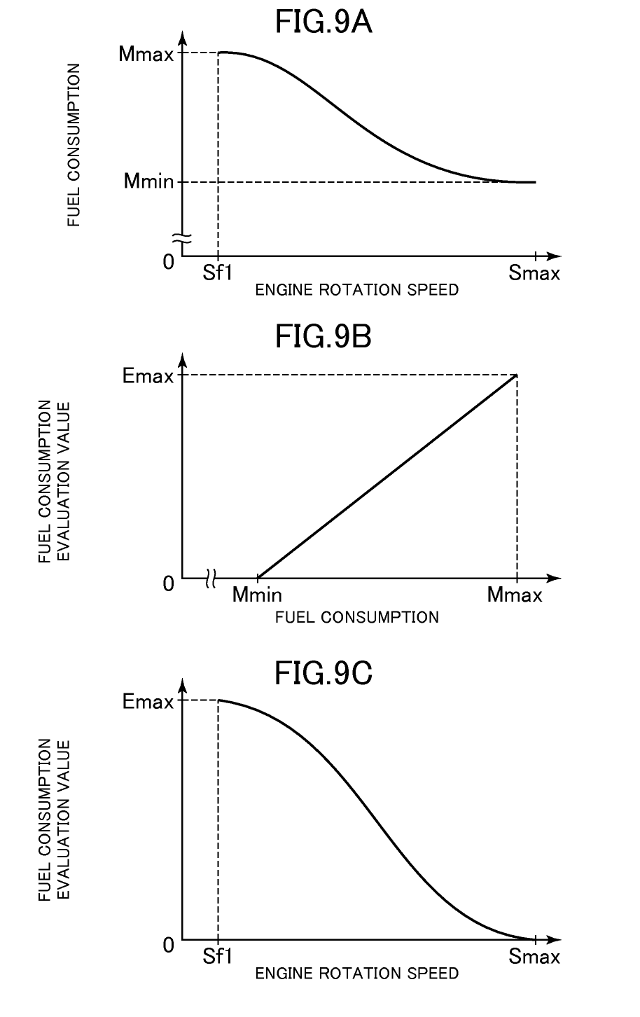

FIGS. 9A through 9C are referred to in order to explain a relationship between the fuel consumption evaluation value, the fuel consumption (km/liter), and the engine rotation speed when the engine power remains constant. FIG. 9A is a graph schematically showing a relationship between the engine rotation speed and the fuel consumption; FIG. 9B is a graph schematically showing a relationship between the fuel consumption and the fuel consumption evaluation value; FIG. 9C is a graph schematically showing a relationship between the engine rotation speed and the fuel consumption evaluation value.

As shown in FIG. 9A, the fuel consumption takes the maximum value Mmax at the above described provisional fuel economy rotation speed Sf1. Generally, the fuel consumption decreases as the engine rotation speed increases from the provisional fuel economy rotation speed Sf1, and takes the minimum value Mmin at the maximum engine rotation speed Smax at which the engine 20 is allowed to drive.

As shown in FIG. 9B, the fuel consumption evaluation value is proportional to the fuel consumption and takes the maximum value EMAX at the maximum value Mmax of the fuel consumption and the minimum value (0 in the example shown in FIG. 9B) at the minimum value Mmin of the fuel consumption. Thus, as shown in FIG. 9C, the fuel consumption evaluation value takes the maximum value Emax at the above described provisional fuel economy rotation speed Sf1. Similar to the fuel consumption, the fuel consumption evaluation value decreases as the engine rotation speed increases from the provisional fuel economy rotation speed Sf1, and takes the minimum value 0 at the maximum engine rotation speed Smax at which the engine 20 is allowed to drive.

The responsive rotation speed calculation section 53c calculates the above described responsive rotation speed based on the vehicle speed detected by the vehicle speed sensor 17 and the calculated target engine power. The responsive rotation speed in this example is an engine rotation speed of the optimal acceleration response within the range of the engine rotation speed which is allowed by changing the transmission ratio. In the storage unit 59, a map that correlates the responsive rotation speed, the vehicle speed, and the engine power (hereinafter referred to as an optimal acceleration response map) is stored. With reference to the optimal acceleration response map, the responsive rotation speed calculation section 53c calculates the responsive rotation speed correlated to the detected vehicle speed and the target engine power.

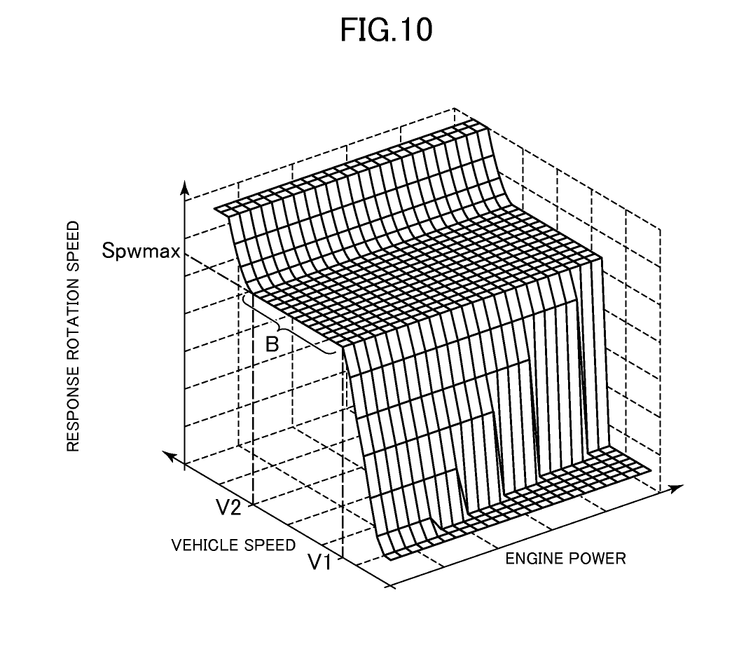

FIG. 10 shows an example of the optimal acceleration response map, in which the three axes indicate the engine power, the vehicle speed, and the responsive rotation speed, respectively.

As described in the above with reference to the graph in FIG. 5B, when the range of the engine rotation speed defined by the upper and lower limits of the transmission ratio is disregarded, the acceleration response (the margin engine power ratio) is optimized at the engine rotation speed Spwmax of the maximum engine power (hereinafter referred to as the maximum power engine rotation speed). Thus, in the optimal acceleration response map, the maximum power engine rotation speed Spwmax is set as the responsive rotation speed, as indicated by the range B in FIG. 10. That is, in an operation area having the maximum power engine rotation speed Spwmax included in the range of the engine rotation speed defined by the upper and lower limits of the transmission ratio and the vehicle speed, the maximum power engine rotation speed Spwmax is set as the responsive rotation speed.

The responsive rotation speed in the optimal acceleration response map is defined as a range of the engine rotation speed defined by the upper and lower limits of the transmission ratio and the vehicle speed. Thus, when the maximum power engine rotation speed Spwmax exceeds the range, either the maximum or minimum value of the range of the engine rotation speed is set as the responsive rotation speed. Specifically, in a speed range lower than the vehicle speed V1 in FIG. 10, the highest engine rotation speed obtained from a product of the vehicle speed times the maximum reduction ratio (the LOW reduction ratio) is lower than the maximum power engine rotation speed Spwmax. Thus, for this range, the highest engine rotation speed is set as the responsive rotation speed. Meanwhile, in a speed range higher than the vehicle speed V2 (V2>V1), the lowest engine rotation speed obtained from a product of the vehicle speed times the minimum reduction ratio (the TOP reduction ratio) is higher than the maximum power engine rotation speed Spwmax. Thus, for this range, the lowest engine rotation speed is set as the responsive rotation speed.

The second evaluation value calculation section 53d calculates the second limit evaluation value based on the responsive rotation speed calculated by the responsive rotation speed calculation section 53c. In this example, as described above, since the fuel consumption evaluation map is stored in the storage unit 59, the second evaluation value calculation section 53d calculates the second limit evaluation value with reference to the fuel consumption evaluation map. For example, as shown in FIG. 8, when the target engine power is PW2 and the responsive rotation speed is Sr, the second evaluation value calculation section 53d calculates, as the second limit evaluation value, a fuel consumption evaluation value Elim2 correlated to the responsive rotation speed Sr and the target engine power PW2 by referring to the fuel consumption evaluation map.

The target engine rotation speed calculation section 53 calculates a target fuel consumption evaluation value between the first limit evaluation value and the second limit evaluation value based on information related to an acceleration request by a driver. Prior to calculation of the target fuel consumption evaluation value, the acceleration request-related value calculation section 53e calculates an acceleration request-related value as information related to an acceleration request.

An acceleration request-related value reflects not only the current acceleration request but also the tendency of past acceleration requests. The acceleration request-related value calculation section 53e calculates an acceleration request-related value that changes as follows, based on an accelerator operation and so forth.

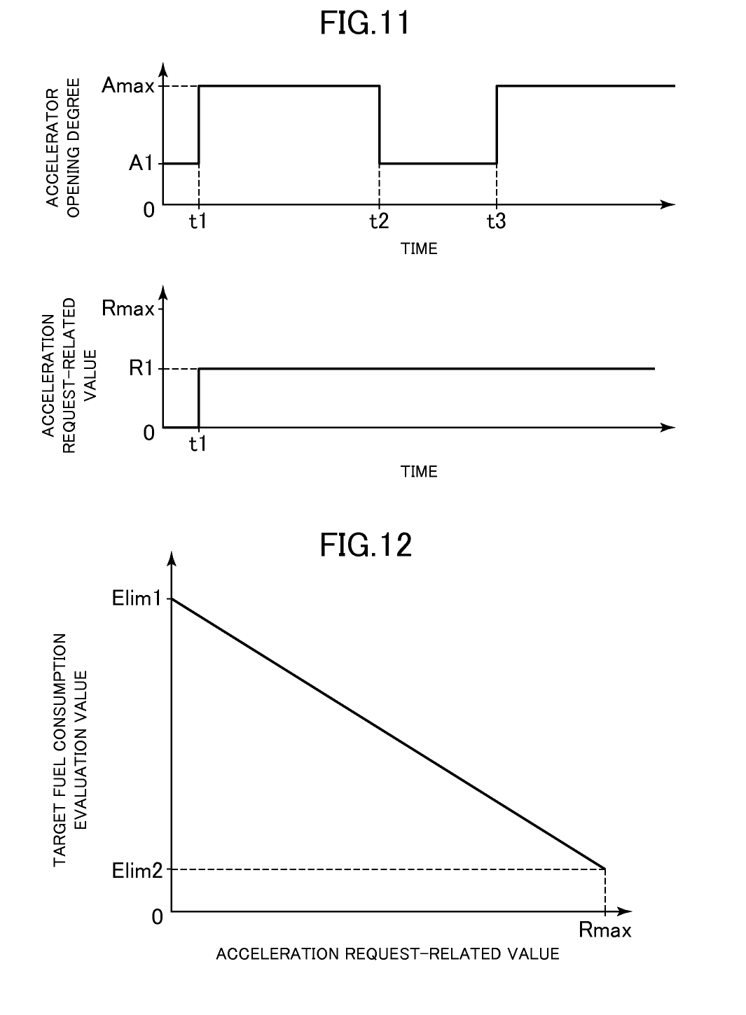

FIG. 11 is a time chart showing an example of change in the accelerator opening degree and the acceleration request-related value. In the diagram, the accelerator opening degree increases at t1 from A1 to the maximum value Amax. Thereafter, the accelerator opening degree decreases to return to A1 at t2, and further, increases again at t3 to Amax. Meanwhile, the acceleration request-related value increases from the minimum value (0 in FIGS. 11) to R1 as the accelerator opening degree increases at t1. Thereafter, although the accelerator opening degree returns to A1 at t2, the accelerator request-related value remains at R1, not following the change of the accelerator opening degree. Further, when the accelerator opening degree returns to Amax at t3, the acceleration request-related value remains at R1 as well. As described above, the acceleration request-related value reflects the accelerator opening degree during a predetermined past period of time.

As a method to calculate such an acceleration request-related value, various methods are available. For example, different conditions are applied when the acceleration request-related value is increasing and decreasing. That is, the acceleration request-related value calculation section 53e increases the acceleration request-related value in accordance with the change of the accelerator opening degree when the change speed of the accelerator opening degree (hereinafter referred to as an accelerator operation speed) is equal to or larger than a predetermined threshold. Meanwhile, when the accelerator opening degree decreases, the acceleration request-related value calculation section 53e gradually decreases the acceleration request-related value in accordance with a lapse time after the accelerator opening degree starts decreasing.

Alternatively, the acceleration request-related value calculation section 53e may calculate the acceleration request-related value based on the accelerator opening degree detected by the accelerator operation sensor 6b, the accelerator operation speed, and an integral value of the accelerator opening degree based on a time, and so forth. For example, the acceleration request-related value calculation section 53e may calculate the acceleration request-related value, using the sum of two or all of the average of the accelerator opening degrees within a predetermined period of time, the accelerator operation speed, and an integral value of the accelerator opening degree based on time.

The acceleration request-related value can be changed continuously or in a stepwise manner between, for example, the maximum value thereof Rmax and the minimum value (0 in FIG. 11). The acceleration request-related value calculated in this example becomes larger as an acceleration request increases (that is, a stronger acceleration request is made, an acceleration request is made more often, or an acceleration request continues for a longer period of time).

The target evaluation value calculation section 53f calculates a target fuel consumption evaluation value between the first limit evaluation value and the second limit evaluation value based on the acceleration request-related value calculated by the acceleration request-related value calculation section 53e. The acceleration request-related value calculated in this example becomes larger as an acceleration request increases, as described above (that is, a stronger acceleration request is made, an acceleration request is made more often, or an acceleration request continues for a longer period of time). Then, the target evaluation value calculation section 53f shifts the target fuel consumption evaluation value from the first limit evaluation value corresponding to the fuel economy rotation speed toward the second limit evaluation value corresponding to the responsive rotation speed as the calculated acceleration request-related value becomes larger. With the above configuration, the target fuel consumption evaluation value comes to the second limit evaluation value in accordance with an increase of the acceleration request, so that higher acceleration response can be obtained.

In this example, the target fuel consumption evaluation value calculated by the target evaluation value calculation section 53f corresponds to the acceleration request-related value. Specifically, the target fuel consumption evaluation value is proportional to the acceleration request-related value, of which the upper limit is defined by either one of the first and second limit evaluation values and the lower limit by the other. In other words, the target evaluation value calculation section 53f calculates, as the target fuel consumption evaluation value, a value that divides the difference between the first and second limit evaluation value in proportion with the acceleration request-related value. For example, the target fuel consumption evaluation value is calculated using, for example, the calculation formula below:

Etg=((Elim1−Elim2)/(Rmax−Rmin))×(R−Rmin)+Elim2
wherein Etg is the target fuel consumption evaluation value, Elim1 is the first limit evaluation value, Elim2 is the second limit evaluation value, R is the acceleration request-related value, Rmax is the maximum value of the acceleration request-related value, and Rmin is the minimum value (for example, 0) of the acceleration request-related value.

FIG. 12 is referred to explain a relationship between the target fuel consumption evaluation value calculated using the above described calculation formula and the acceleration request-related value, wherein the x-axis indicates the acceleration request-related value and the y-axis indicates the target fuel consumption evaluation value.

As shown in FIG. 12, the target fuel consumption evaluation value calculated using the above-described calculation formula is proportional to the acceleration request-related value. When the acceleration request-related value takes the maximum value Rmax, the second limit evaluation value Elim2 is calculated as the target fuel consumption evaluation value, and when the acceleration request-related value takes the minimum value 0, the first limit evaluation value Elim1 is calculated as the target fuel consumption evaluation value.

The target rotation speed calculation section 53g calculates the target engine rotation speed based on the target fuel consumption evaluation value. Specifically, with reference to the fuel consumption evaluation map, the target rotation speed calculation section 53g calculates a target engine rotation speed correlated to the target fuel consumption evaluation value. The fuel consumption evaluation map in this example correlates the fuel consumption evaluation value, the engine power, and the engine rotation speed, as described above. The target rotation speed calculation section 53g calculates, as the target engine rotation speed, an engine rotation speed correlated to the calculated target fuel consumption evaluation value and the target engine power by referring to the fuel consumption evaluation map.

Referring to FIG. 8, when the target fuel consumption evaluation value is Etg (Elim2<Etg<Elim1) and the target engine power is PW2, an engine rotation speed Stg correlated to the target fuel consumption evaluation value and the target engine power is calculated as the target engine rotation speed. Since the target fuel consumption evaluation value Etg is a value between the first limit evaluation value (Elim1 or Emax in FIG. 8) and the second limit evaluation value Elim2, the calculated target engine rotation speed Stg is between the fuel economy rotation speed (Sf2 or Sf1 in FIG. 8) and the responsive rotation speed Sr.

The fuel consumption evaluation map used by the target rotation speed calculation section 53g may not necessarily coincide with that which is used by the above described first evaluation value calculation section 53b and the second evaluation value calculation section 53d. That is, two maps may be stored as the fuel consumption evaluation map in the storage unit 59. The fuel consumption evaluation map used by the first evaluation value calculation section 53b or the like is defined by only an operation area used in calculation of the first limit evaluation value or the like, while the fuel consumption evaluation map used by the target rotation speed calculation section 53g may be defined by only an operation area used in processing to calculate the target engine rotation speed.

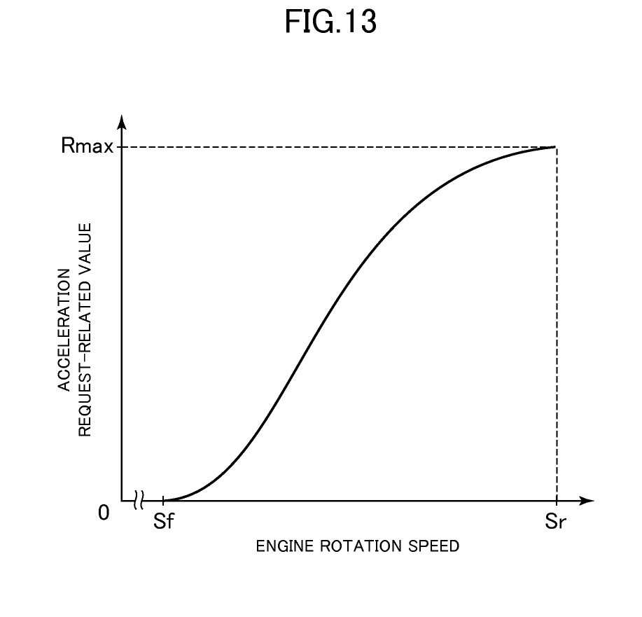

FIG. 13 schematically shows a relationship between the target engine rotation speed calculated as described above and the acceleration request-related value, in which the x-axis indicates the target engine rotation speed and the y-axis indicates the acceleration request-related value.

As shown in FIG. 12, the acceleration request-related value is proportional to the fuel consumption evaluation value, with the maximum value thereof corresponding to the second limit evaluation value, and the minimum value thereof (0 in FIG. 12) corresponding to the first limit evaluation value. Thus, as shown in FIG. 13, when the acceleration request-related value takes the maximum value Rmax, the acceleration responsive rotation speed (Sr in FIG. 13) is calculated as the target engine rotation speed. As the acceleration request-related value becomes smaller, the target engine rotation speed becomes lower, gradually becoming closer to the fuel economy rotation speed (Sf in FIG. 13). Then, when the acceleration request-related value takes the minimum value 0, the fuel economy rotation speed becomes the target engine rotation speed.

When the fuel consumption evaluation value and the engine rotation speed have a relationship expressed by function Fe (E=Fe(S), E=fuel consumption evaluation value, S=engine rotation speed), Etg=Fe(Stg), Elim1=Fe(Sf), and Elim2=Fe(Sr), in which Etg is the target fuel consumption evaluation value, Stg is the target engine rotation speed, Elim1 is the first limit evaluation value, Elim2 is the second limit evaluation value, Sf is the fuel economy rotation speed, and Sr is the responsive rotation speed. As shown in FIG. 12, a relationship between the target fuel consumption evaluation value Etg and the acceleration request-related value R is expressed as:

Etg=((Elim1−Elim2)/(Rmin−Rmax))×(R−Rmax)+Elim2

Thus, the relationship between the target engine rotation speed and the acceleration request-related value shown in FIG. 13 is expressed by the following function Fr (R=Fr(Stg), wherein R=acceleration request-related value and Stg=target engine rotation speed):

Fr(Stg)=(Rmax−Rmin)/(Fe(Sr)−Fe(Sf))×(Fe(Stg)−Fe(Sf))+Rmin

In particular, since the minimum value Rmin of the acceleration request-related value is 0 in FIG. 13, the following relational expression is held:

Fr(Stg)=Rmax/(Fe(Sr)−Fe(Sf))×(Fe(Stg)−Fe(Sf))

In the intermediate mode, the target transmission ratio is calculated based on the target engine rotation speed calculated as described above and the current vehicle speed. When the actual transmission ratio becomes equal to the target transmission ratio, the actual engine rotation speed coincides with the target engine rotation speed. In the above, the engine 20 is driven at a fuel consumption corresponding to the target fuel consumption evaluation value.

When the target engine rotation speed calculation section 53 has the above described function, the target engine rotation speed is calculated as described below, for example, in the fuel economy mode and the acceleration responsive mode.

The fuel economy mode is for driving the engine 20 at the above-described fuel economy rotation speed. Thus, in the fuel economy mode, the target engine rotation speed calculation section 53 calculates, as the target engine rotation speed, the fuel economy rotation speed calculated by the fuel economy rotation speed calculation section 53a, without the processing by the first evaluation value calculation section 53b or the like. Meanwhile, the acceleration responsive mode is for driving the engine 20 at the above-described responsive rotation speed. Thus, in the acceleration responsive mode, the target engine rotation speed calculation section 53 calculates, as the target engine rotation speed, the responsive rotation speed calculated by the responsive rotation speed calculation section 53c, without the processing by the second evaluation value calculation section 53d or the like.

In the fuel economy mode, the acceleration responsive mode, and the intermediate mode, the respective sections of the target engine rotation speed calculation section 53 may execute the same processing with a parameter alone differing. That is, in the fuel economy mode, the minimum value of the acceleration request-related value may be calculated, and the target evaluation value calculation section 53f may execute processing similar to the above described processing, based on the calculated minimum value, to calculate the target fuel consumption evaluation value. With the above configuration, an engine rotation speed of the optimal fuel consumption, that is, the fuel economy rotation speed, is calculated as the target engine rotation speed among the engine rotation speeds which can produce the target engine power. Meanwhile, in the acceleration responsive mode, the maximum value of the acceleration request-related value may be calculated, and the target evaluation value calculation section 53f may execute processing similar to the above described processing, based on the calculated maximum value, to calculate the target fuel consumption evaluation value. With the above configuration, an engine rotation speed which can realize the optimal acceleration response, that is, the responsive rotation speed, is calculated as the target engine rotation speed.

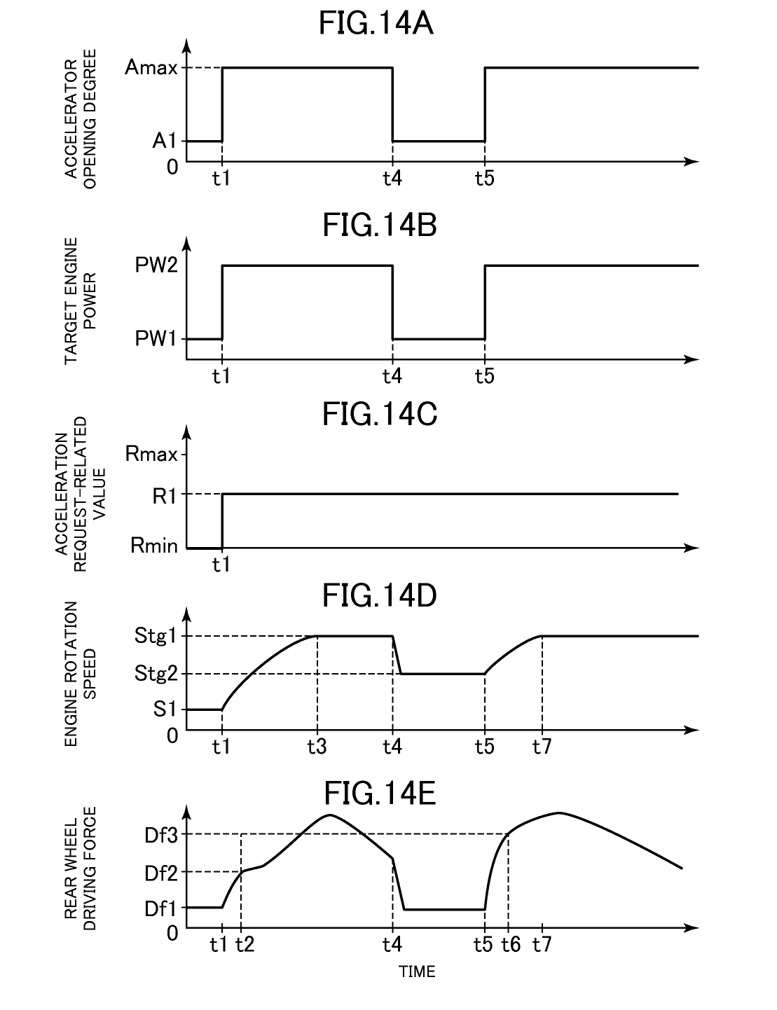

FIGS. 14A through 14E are time charts showing an example of a change in the accelerator opening degree, the target engine power, the acceleration request-related value, the actual engine rotation speed, and the rear wheel driving force.

As shown in FIG. 14A, in this description, the accelerator opening degree increases at t1 from A1 to the maximum value Amax. Thereafter, the accelerator opening degree decreases at t4 to return to A1, and then increases again at t5 from A1 to the maximum value Amax. Meanwhile, the target engine power increases at t1 from PW1 to PW2, and thereafter decreases to PW1 at t4, following the above described change in the accelerator opening degree. Then, the target engine power increases again at t5 from PW1 to PW2. Before t1, the acceleration request-related value is set to the minimum value Rmin, and the engine 20 is driven in the above described fuel economy mode. As a result, before t1, the engine rotation speed remains at the fuel economy rotation speed S1 that is calculated based on the minimum value Rmin of the acceleration request-related value and the target engine power PW1. Under this assumption, the operation state of the engine 20 changes, for example as follows.

When the accelerator opening degree increases to the maximum value Amax, the engine rotation speed starts increasing from S1 toward the target engine rotation speed Stg1 that is newly set in accordance with an increase of the accelerator opening degree and target engine power (t1). In this example, the acceleration request-related value increases from the minimum value Rmin to R1, following the increase of the accelerator opening degree at t1. Thus, when the accelerator opening degree increases at t1, the target engine rotation speed Stg1 is set to a rotation speed calculated based on the acceleration request-related value R1 and the target engine power PW2 that is higher than the engine rotation speed of the optimal fuel consumption, i.e., the fuel economy rotation speed. As shown in FIG. 14D, the actual engine rotation speed gradually increases toward the target engine rotation speed Stg1 to reach the target engine rotation speed Stg1 at t3.

Before the engine rotation speed reaches the target engine rotation speed Stg1, the engine torque instantly increases toward the target engine torque calculated based on the current engine rotation speed and the target engine power PW2. Thus, as shown in FIG. 14E, the rear wheel driving force increases from Df1 to Df2 immediately after the increase of the accelerator opening degree (t2). Then, the rear wheel driving force gradually increases, following the increase of the engine rotation speed, and thereafter, gradually decreases due to the increase of the vehicle speed.

At t4, the accelerator opening degree and the target engine power return to A1 and PW1, respectively. However, in this description, the acceleration request-related value remains at R1. Thus, when the target engine power returns to PW1, the target engine rotation speed is set to the engine rotation speed Stg2 (that is, the rotation speed calculated based on the acceleration request-related value R1 and the target engine power PW1) that is higher than the fuel economy rotation speed correlated to the target engine power PW1. At t4, the engine rotation speed starts decreasing toward the rotation speed Stg2.

When the accelerator opening degree and the target engine power increase at t5, the engine rotation speed starts increasing gradually from Stg2 toward the target engine rotation speed (Stg1 here) calculated based on the acceleration request-related value R1 and the target engine power PW2. Then, the engine rotation speed reaches the target engine rotation speed Stg1 at t7.

With the acceleration at t5, the engine torque instantly increases toward the target engine torque calculated based on the current engine rotation speed and the target engine power PW2 before the engine rotation speed reaches the target engine rotation speed Stg1. Thus, the rear wheel driving force increases from Df1 to Df3 immediately after the increase of the accelerator opening degree (t6). As described above, immediately before the acceleration at t5, the engine rotation speed has been set higher than the fuel economy rotation speed, in other words, the rotation speed Stg2, which is close to the responsive rotation speed. Thus, the engine power obtained immediately after the acceleration at t5, that is, immediately after the increase of the accelerator opening degree and the target engine power at t5, is higher than the engine power obtained immediately after the acceleration at t1. As a result, a larger rear wheel driving force Df3 can be obtained immediately after the acceleration at t5 than the rear wheel driving force Df2 obtained immediately after the acceleration at t1, so that a preferable acceleration response can be obtained.

In the above described preferred embodiments of the present invention, data which correlates each engine rotation speed with the fuel consumption evaluation value indicating a fuel consumption when driving the engine 20 at that engine rotation speed (the fuel consumption evaluation map here) is stored in advance in the storage unit 59. Then, the target evaluation value calculation section 53f calculates a target fuel consumption evaluation value between the first limit evaluation value indicating a fuel consumption when driving the engine 20 in the fuel economy mode and the second limit evaluation value indicating a fuel consumption when driving the engine 20 in the acceleration responsive mode. Then, with reference to the data stored in the storage unit 59, the target engine rotation speed calculation section 53 calculates, as the target engine rotation speed, the engine rotation speed correlated to the target fuel consumption evaluation value. With the above configuration, it is possible to drive the engine 20 at the fuel consumption corresponding to the target evaluation value when the actual engine rotation speed reaches the target engine rotation speed.

In another preferred embodiment of the present invention, the evaluation value may not be a value indicating a fuel consumption, but a value indicating an acceleration response. In this preferred embodiment, a map which correlates each engine rotation speed of the engine 20 with an evaluation value indicating an acceleration response when driving the engine 20 at that engine rotation speed (hereinafter referred to as a response evaluation value) is stored in the storage unit 59. Then, the target engine rotation speed calculation section 53 sets a target value of the response evaluation value, and calculates the target engine rotation speed based on the target value.

In this preferred embodiment, the first limit evaluation value is a response evaluation value indicating an acceleration response when driving the engine 20 in the fuel economy mode, and the second limit evaluation value is a response evaluation value indicating an acceleration response when driving the engine 20 in the acceleration responsive mode. The target engine rotation speed calculation section 53 calculates a target response evaluation value (hereinafter referred to as a target response evaluation value) between the first limit evaluation value and the second limit evaluation value, and then, with reference to the map stored in the storage unit 59, calculates, as the target engine rotation speed, an engine rotation speed correlated to the target response evaluation value. With the above configuration, when the actual engine rotation speed reaches the target engine rotation speed, an acceleration response correlated to the target response evaluation value is obtained. In the following, processing of the target engine rotation speed calculation section 53 in this preferred embodiment will be described in detail.

Respective functions and processing of the target engine rotation speed calculation section 53 in this preferred embodiment are substantially the same as those in the above described preferred embodiments, except for the processing by the first evaluation value calculation section 53b, the second evaluation value calculation section 53d, and the target rotation speed calculation section 53g.

In this preferred embodiment, a map which correlates each engine rotation speed, each engine power, and the response evaluation value indicating an acceleration response when driving the engine 20 at that engine rotation speed and that engine power (hereinafter referred to as an acceleration response evaluation map) is stored in the storage unit 59. With reference to the acceleration response evaluation map, the first evaluation value calculation section 53b and the second evaluation value calculation section 53d calculate the first limit evaluation value and the second limit evaluation value, respectively.

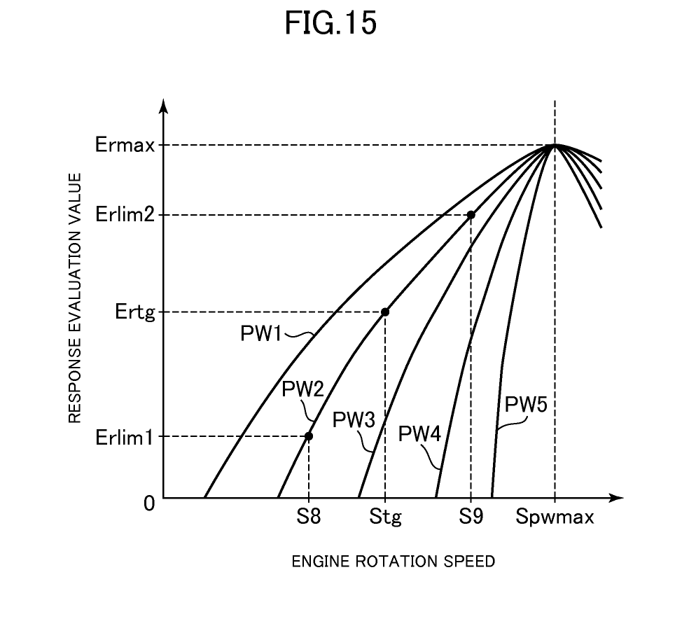

FIG. 15 explains the acceleration response evaluation map, wherein the x-axis indicates the engine rotation speed and the y-axis indicates the response evaluation value. This diagram further shows a relationship between the engine rotation speed and the response evaluation value as to the respective engine powers PW1 to PW5 (PW1<PW2< . . . <PW5).

As described above, the acceleration response is maximized at the maximum power engine rotation speed Spwmax that achieves the maximum engine power PWmax (see FIG. 5B). Thus, as shown in FIG. 15, the response evaluation value takes the maximum value Ermax at the maximum power engine rotation speed Spwmax. As a difference between the engine rotation speed and the maximum power engine rotation speed Spwmax becomes larger, the response evaluation value becomes smaller. Then, the response evaluation value takes the minimum value (0 in FIG. 15) at an engine rotation speed of the smallest acceleration response at each engine rotation speed.

The acceleration response in a certain operation state is a ratio of an engine power in that operation state relative to the maximum engine power that can be obtained at an engine rotation speed of that operation state (PW3max/PW3 in FIG. 5B), as described above. Then, when the engine power is supposed to remain constant, the acceleration response is minimized at the rotation speed at a cross point between the equivalent power curve line indicative of the engine power (for example, line L3 in FIG. 5A) and the maximum torque curve line Ltmax (point Pot in FIG. 5A). Thus, the response evaluation value is minimized at the engine rotation speed at the cross point.

In this preferred embodiment, with reference to the acceleration response evaluation map, the first evaluation value calculation section 53b calculates the first limit evaluation value based on the fuel economy rotation speed calculated by the fuel economy rotation speed calculation section 53a. As shown in FIG. 15, for example, supposing that the calculated fuel economy rotation speed and target engine power are S8 and PW2, respectively, the first evaluation value calculation section 53b calculates, as the first limit evaluation value, the response evaluation value Erlim1 correlated to the fuel economy rotation speed S8 and the target engine power PW2.

Further, with reference to the acceleration response evaluation map, the second evaluation value calculation section 53d calculates the second limit evaluation value based on the responsive rotation speed calculated by the responsive rotation speed calculation section 53c. As shown in FIG. 15, for example, supposing that the calculated responsive rotation speed and the target engine power are S9 and PW2, respectively, the second evaluation value calculation section 53d calculates, as the second limit evaluation value, the response evaluation value Erlim2 correlated to the responsive rotation speed S9 and the target engine power PW2.

As described above, the responsive rotation speed optimizes the acceleration response within the range of the engine rotation speed that is allowed by changing the transmission ratio. Thus, when the maximum power engine rotation speed Spwmax is included in that range, the maximum value Ermax of the response evaluation value is calculated as the second limit evaluation value. Meanwhile, when the maximum power engine rotation speed Spwmax exceeds the range, a response evaluation value correlated to the engine rotation speed at the upper or lower limit of the range is calculated as the second limit evaluation value.

In this preferred embodiment as well, the target evaluation value calculation section 53f calculates a targeted response evaluation value (that is, the target response evaluation value) between the first limit evaluation value and the second limit evaluation value, based on the acceleration request-related value. Specifically, similar to the above described preferred embodiment, the target evaluation value calculation section 53f calculates, as the target response evaluation value, a value that divides the difference between the first limit evaluation value and the second limit evaluation value in a proportion in accordance with the acceleration request-related value. The target evaluation value calculation section 53f calculates the target response evaluation value, using, for example, the calculation formula below:

Ertg=((Erlim2−Erlim1)/(Rmax−Rmin))×(R−Rmin)+Erlim1
wherein Ertg is the target response evaluation value, Erlim1 is the first limit evaluation value in this preferred embodiment, Erlim2 is the second limit evaluation value in this preferred embodiment, R is the acceleration request-related value, Rmax is the maximum value of the acceleration request-related value, and Rmin is the minimum value of the acceleration request-related value. Use of such a calculation formula can make the target response evaluation value be proportional to the acceleration request-related value and become closer to the second limit evaluation value as the acceleration request-related value becomes closer to the maximum value thereof.

In this preferred embodiment as well, a larger acceleration request-related value is calculated as the acceleration request increases. As a result, the target response evaluation value becomes closer to the second limit evaluation value correlated to the responsive rotation speed as the acceleration request increases, so that a higher acceleration response can be obtained.

With reference to the acceleration response evaluation map, the target rotation speed calculation section 53g calculates the target engine rotation speed based on the target response evaluation value. That is, with reference to the acceleration response evaluation map, the target rotation speed calculation section 53g calculates, as the target engine rotation speed, the rotation speed correlated to the target response evaluation value and the target engine power. With reference to FIG. 15, supposing that the target response evaluation value and the target engine power are Ertg (Erlim1<Ertg<Erlim2) and PW2, respectively, the target rotation speed calculation section 53g calculates, as the target engine rotation speed, the engine rotation speed Stg correlated to the target response evaluation value Ertg and the target engine power PW2.

The acceleration response evaluation map used by the target rotation speed calculation section 53g may differ from the acceleration response evaluation map used by the first evaluation value calculation section 53b and the second evaluation value calculation section 53d. That is, two mutually different acceleration response evaluation maps may be stored in the storage unit 59. Then, the acceleration response evaluation map used by the first evaluation value calculation section 53b or the like may be defined only by an operation area used in the processing for calculating the first limit evaluation value or the like, while the acceleration response evaluation map used in the target rotation speed calculation section 53g may be defined only by an operation area used in the processing for calculating the target engine rotation speed. For example, as shown in FIG. 15, the acceleration response evaluation map used by the first evaluation value calculation section 53b or the like is also defined as an engine rotation speed higher than the maximum power engine rotation speed Spwmax. However, the acceleration response evaluation map used by the target rotation speed calculation section 53g may be defined only as a range lower than the maximum power engine rotation speed Spwmax.

In another preferred embodiment of the present invention, data (an acceleration response evaluation map here) which correlates each engine rotation speed with a response evaluation value indicating an acceleration response when driving the engine 20 at that engine rotation speed is stored in advance in the storage unit 59. Then, the target evaluation value calculation section 53f calculates a targeted response evaluation value (that is, a target response evaluation value) between the first limit evaluation value indicating an acceleration response when driving the engine 20 in the fuel economy mode and the second limit evaluation value indicating an acceleration response when driving the engine 20 in the acceleration responsive mode. With reference to the data stored in the storage unit 59, the target engine rotation speed calculation section 53 calculates, as the target engine rotation speed, an engine rotation speed correlated to the target response evaluation value. Thus, when the actual engine rotation speed becomes equal to the target engine rotation speed, it is possible to obtain an acceleration response correlated to the target response evaluation value.

In the above described preferred embodiments, the target evaluation value calculation section 53f calculates the target fuel consumption evaluation value or the target response evaluation value based on information related to an acceleration request by a driver (an acceleration request-related value in the above description). Thus, it is possible to drive the engine 20 at a fuel consumption or an acceleration response in accordance with an acceleration request by a driver.

In the above described preferred embodiments, the acceleration request-related value is calculated based on an accelerative operation by a driver. Thus, it is possible to obtain a fuel consumption and an acceleration response in accordance with an accelerator operation.

In the above described preferred embodiments, the target evaluation value calculation section 53f shifts the target fuel consumption evaluation value or the target response evaluation value from the first limit evaluation value toward the second limit evaluation value in accordance with an increase of an acceleration request by a driver. Thus, it is possible to obtain higher an acceleration response when the acceleration request by a driver increases.

In the above described preferred embodiments, the acceleration request-related value is calculated as information related to an acceleration request by a driver, and the target fuel consumption evaluation value and the target response evaluation value take values in proportion to the acceleration request-related value. Thus, it is possible to obtain a fuel consumption and an acceleration response in accordance with the acceleration request-related value.

In the above described preferred embodiments, the drive control device 10 includes the fuel economy rotation speed calculation section 53a which calculates an engine rotation speed at which the engine 20 is set in the fuel economy mode (that is, the fuel economy rotation speed) and the first evaluation value calculation section 53b which calculates the first limit evaluation value based on the fuel economy rotation speed. Thus, compared to a case in which neither the fuel economy rotation speed nor the first limit evaluation value is calculated in calculation of the target engine rotation speed (for example, when the target evaluation value is calculated directly from the accelerator opening degree, the vehicle speed, and the target engine power using a calculation formula), the target engine rotation speed can be calculated more simply.

In the above described preferred embodiments, the drive control device 10 includes the responsive rotation speed calculation section 53c which calculates an engine rotation speed (that is, responsive rotation speed) at which the engine 20 is set in the acceleration responsive mode and the second evaluation value calculation section 53d which calculates the second limit evaluation value based on the responsive rotation speed. Thus, compared to a case in which neither the responsive rotation speed nor the second limit evaluation value is calculated in calculation of the target engine rotation speed (for example, when the target evaluation value is calculated directly from the accelerator opening degree, the vehicle speed, and the target engine power using a calculation formula), the target engine rotation speed can be calculated more simply.

Note that the present invention is not limited to the above described preferred embodiments, and various modifications are possible.

For example, in the above description, a map is preferably stored in the storage unit 59 as data which correlates the engine rotation speed with the fuel consumption evaluation value or the response evaluation value. However, instead of a map, a relational formula which correlates the engine rotation speed and the fuel consumption evaluation value or the response evaluation value may be stored in the storage unit 59.

In the above description, the acceleration request-related value preferably is calculated based on an accelerator operation. However, the acceleration request-related value may be manually input by a driver. For example, a switch for a driver's operation may be mounted on the steering bar 6 or the like, so that the acceleration request-related value calculation section 53e calculates a value in accordance with an output signal from the switch as the acceleration request-related value. Further, the acceleration request-related value calculation section 53e may calculate the acceleration request-related value based on a vehicle acceleration and frequency of acceleration made during a predetermined period of time.

Although the first limit evaluation value and the second evaluation value are preferably calculated in the calculation of the target engine rotation speed in the above description, the first limit evaluation value and the second limit evaluation value may not be calculated in the calculation of the target engine rotation speed. For example, a targeted evaluation value may be calculated directly from the acceleration request-related value, the vehicle speed, and the target engine power using a calculation formula, as long as the resulting calculated target evaluation value becomes a value between the first limit evaluation value and the second limit evaluation value.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-9. (canceled)

10. A drive control device for a vehicle that controls an engine and a transmission ratio of a continuously variable transmission so that an operation state of the engine becomes a target operation state, the drive control device comprising:
a storage unit arranged to store in advance data that correlates each operation state of the engine with an evaluation value indicating a fuel consumption when driving the engine at each operation state;
a target evaluation value calculation section arranged and programmed to calculate a targeted evaluation value between a first evaluation value indicating a fuel consumption when driving the engine in a fuel economy mode and a second evaluation value indicating a fuel consumption when driving the engine in an acceleration responsive mode; and
a target operation state calculation section arranged and programmed to calculate, as the target operation state, an operation state correlated to the targeted evaluation value by referring to the data stored in the storage unit.

11. The drive control device for a vehicle according to claim 10, wherein the target evaluation value calculation section is arranged and programmed to calculate the targeted evaluation value based on information related to an acceleration request by a driver.

12. The drive control device for a vehicle according to claim 11, wherein the information related to an acceleration request by the driver is obtained based on an operation of an accelerator by the driver.

13. The drive control device for a vehicle according to claim 11, wherein the target evaluation value calculation section is arranged and programmed to change the targeted evaluation value from the first evaluation value toward the second evaluation value when the acceleration request by the driver increases.

14. The drive control device for a vehicle according to claim 13, wherein
an acceleration request-related value is calculated as the information related to the acceleration request by the driver; and
the targeted evaluation value is proportional to the acceleration request-related value.

15. The drive control device for a vehicle according to claim 10, further comprising:
a first operation state calculation section arranged and programmed to calculate an operation state at which the engine driven in the fuel economy mode is set; and
a first evaluation value calculation section arranged and programmed to calculate the first evaluation value based on the operation state calculated by the first operation state calculation section.

16. The drive control device for a vehicle according to claim 10, further comprising:
a second operation state calculation section arranged and programmed to calculate an operation state at which the engine driven in the acceleration responsive mode is set; and
a second evaluation value calculation section arranged and programmed to calculate the second evaluation value based on the operation state calculated by the second operation state calculation section.

17. A vehicle comprising:
the drive control device according to claim 10.

18. A drive control device for a vehicle that controls an engine and a transmission ratio of a continuously variable transmission so that an operation state of the engine becomes a target operation state, the drive control device comprising:
a storage unit arranged to store in advance data which correlates each operation state of the engine with an evaluation value indicating an acceleration response when driving the engine at each operation state;
a target evaluation value calculation section arranged and programmed to calculate a targeted evaluation value between a first evaluation value indicating an acceleration response when driving the engine in a fuel economy mode and a second evaluation value indicating an acceleration response when driving the engine in an acceleration responsive mode; and
a target operation state calculation section arranged and programmed to calculate, as the target operation state, an operation state correlated to the targeted evaluation value by referring to the data stored in the storage unit.

19. The drive control device for a vehicle according to claim 18, wherein the target evaluation value calculation section is arranged and programmed to calculate the targeted evaluation value based on information related to an acceleration request by a driver.

20. The drive control device for a vehicle according to claim 19, wherein the information related to an acceleration request by the driver is obtained based on an operation of an accelerator by the driver.

21. The drive control device for a vehicle according to claim 19, wherein the target evaluation value calculation section is arranged and programmed to change the targeted evaluation value from the first evaluation value toward the second evaluation value when the acceleration request by the driver increases.

22. The drive control device for a vehicle according to claim 21, wherein
an acceleration request-related value is calculated as the information related to the acceleration request by the driver; and
the targeted evaluation value is proportional to the acceleration request-related value.

23. The drive control device for a vehicle according to claim 18, further comprising:
a first operation state calculation section arranged and programmed to calculate an operation state at which the engine driven in the fuel economy mode is set; and
a first evaluation value calculation section arranged and programmed to calculate the first evaluation value based on the operation state calculated by the first operation state calculation section.

24. The drive control device for a vehicle according to claim 18, further comprising:
a second operation state calculation section arranged and programmed to calculate an operation state at which the engine driven in the acceleration responsive mode is set; and
a second evaluation value calculation section arranged and programmed to calculate the second evaluation value based on the operation state calculated by the second operation state calculation section.

25. A vehicle comprising:
the drive control device according to claim 18.
